(19) United States
(12) Patent Application Publication
(10) Pub. No.: US 2016/0146851 A1
(43) Pub. Date: May 26, 2016

(54) PHYSICAL QUANTITY SENSOR, ELECTRONIC DEVICE, AND MOVING OBJECT

(71) Applicant: Seiko Epson Corporation, Tokyo (JP)

(72) Inventor: Shinichi KAMISUKI, Shiojiri (JP)

(21) Appl. No.: 14/943,398

(22) Filed: Nov. 17, 2015

(30) Foreign Application Priority Data
Nov. 21, 2014 (JP) 2014-236284

(51) Int. Cl. G01P 15/125

(52) U.S. Cl. CPC G01P 15/125

(57) ABSTRACT

A physical quantity sensor includes an element piece, a support substrate in which the element piece is arranged on one surface and a groove is disposed on the one surface, wiring which is disposed in the groove and is electrically connected to the element piece, a lid substrate which is bonded to the one surface and contains the element piece, and a sealing material which seals the groove in a boundary portion between the lid substrate and the support substrate and has a melting point lower than a melting point or a softening point of the support substrate and the lid substrate.

### BACKGROUND

1. Technical Field

The present invention relates to a physical quantity sensor, an electronic device, and a moving object.

2. Related Art

From the related art, a physical quantity sensor detecting a physical quantity such as angular velocity or acceleration has been known (for example, JP-A-2005-249454).

A physical quantity sensor disclosed in JP-A-2005-249454 is a capacitive acceleration sensor including an inertia mass body, a movable electrode, a fixed electrode, wiring, a substrate supporting the inertia mass body, the movable electrode, the fixed electrode, and the wiring, an upper surface protective substrate which is disposed on an upper surface side of the substrate and includes a concave portion containing the inertia mass body, the movable electrode, and the fixed electrode, and a lower surface protective substrate which is disposed on a lower surface side of the substrate.

In the physical quantity sensor, the wiring is disposed on the upper surface side of the substrate. In addition, the upper surface protective substrate has a size smaller than that of the substrate in a plan view. For this reason, the upper surface protective substrate is bonded to the substrate through the wiring in order to cross the wiring, and a part of the wiring is derived into an outer side of the upper surface protective substrate.

In addition, at least a portion of the wiring to which the substrate and the upper surface protective substrate are bonded is covered with the insulating layer. Accordingly, the wiring is in non-contact with the substrate and the upper surface protective substrate.

However, it is comparatively difficult to form the wiring and the insulating film to be flat. For this reason, in the physical quantity sensor disclosed in JP-A-2005-249454, it is difficult to airtightly bond the upper surface protective substrate to the substrate. Therefore, airtightness of a concave portion becomes insufficient.

Thus, when the wiring is derived into the outer side of the upper surface protective substrate, it is difficult to airtightly seal the inertia mass body, the movable electrode, the fixed electrode, and the like.

### SUMMARY

An advantage of some aspects of the invention is to provide a physical quantity sensor capable of easily and airtightly sealing a sensor element, an electronic device, and a moving object.

The invention can be attained by the following application examples.

### APPLICATION EXAMPLE 1

According to this application example, there is provided a physical quantity sensor including a sensor element; a support substrate in which the sensor element is arranged on one surface and a groove is disposed on the one surface; wiring which is disposed in the groove and is electrically connected to the sensor element; a lid substrate which is bonded to the one surface and contains the sensor element; and a sealing material which seals the groove in a boundary portion between the lid substrate and the support substrate in the groove and has a melting point lower than a melting point or a softening point of the support substrate and the lid substrate.

Accordingly, it is possible to derive the wiring into the outer side of the lid substrate by disposing the wiring in the groove formed on the support substrate, and it is possible to airtightly bond the lid substrate to the support substrate by using the flatness of these substrates.

In addition, it is possible to ensure airtightness of the inner side of the lid substrate by locally sealing the groove positioned in the boundary portion between the lid substrate and the support substrate.

Therefore, according to the invention, even when the wiring is derived into the outer side of the lid substrate, it is possible to easily and airtightly seal a space in which the sensor element is contained.

### APPLICATION EXAMPLE 2

In the physical quantity sensor according to the application example, it is preferable that a through hole which passes through the lid substrate in a thickness direction and is communicated with the groove is formed in the lid substrate, and the groove in the boundary portion formed by the through hole is sealed with the sealing material.

Accordingly, it is possible to allow the groove to be easily filled with the sealing material through the through hole. Accordingly, it is possible to more easily seal the space in which the sensor element is contained.

### APPLICATION EXAMPLE 3

In the physical quantity sensor according to the application example, it is preferable that the sealing material collectively seals the through hole and the groove.

Accordingly, it is possible to further increase airtightness of the space in which the sensor element is contained, and thus the physical quantity sensor has excellent reliability.

### APPLICATION EXAMPLE 4

In the physical quantity sensor according to the application example, it is preferable that a plurality of the grooves are disposed, and the through hole intersects each of the plurality of grooves in a plan view of the lid substrate.

Accordingly, even when the plurality of grooves are disposed, it is possible to collectively seal the respective grooves. Accordingly, the physical quantity sensor has excellent productivity.

### APPLICATION EXAMPLE 5

In the physical quantity sensor according to the application example, it is preferable that the sealing material is arranged in a position which is the boundary portion and an edge portion of the lid substrate.

Accordingly, it is possible to allow the groove to be filled with the sealing material from the edge portion of the lid substrate. Accordingly, it is possible to more easily seal the space in which the sensor element is contained.

### APPLICATION EXAMPLE 6

In the physical quantity sensor according to the application example, it is preferable that the sealing material includes a metal material or a glass material having a low melting point.

Accordingly, it is possible to increase the airtightness of the space in which the sensor element is contained, and thus the physical quantity sensor has more excellent reliability.

### APPLICATION EXAMPLE 7

In the physical quantity sensor according to the application example, it is preferable that the physical quantity sensor further includes an insulating layer which covers a surface of the wiring.

Accordingly, even when the sealing material has conductivity, it is possible to prevent a plurality of wirings from being short-circuited.

### APPLICATION EXAMPLE 8

According to this application example, there is provided an electronic device including the physical quantity sensor according to the application example.

Accordingly, it is possible to obtain an electronic device having high reliability.

### APPLICATION EXAMPLE 9

According to this application example, there is provided a moving object including the physical quantity sensor according to the application example.

Accordingly, it is possible to obtain a moving object having high reliability.

### BRIEF DESCRIPTION OF THE DRAWINGS

The invention will be described with reference to the accompanying drawings, wherein like numbers reference like elements.

FIG. 1 is a perspective view illustrating a first embodiment of a physical quantity sensor of the invention.

FIG. 2 is a plan view illustrating the physical quantity sensor illustrated in FIG. 1.

FIG. 3 is a sectional view cut along line III-III of FIG. 2.

FIG. 4 is a partially enlarged view (an enlarged sectional view) of FIG. 3.

FIG. 5 is a partially enlarged view of a sectional view cut along line V-V of FIG. 2.

FIG. 6A is a top view of a through hole, and FIG. 6B is a sectional view cut along line VIB-VIB of FIG. 5.

FIGS. 7A and 7B are sectional views illustrating a manufacturing method of the physical quantity sensor illustrated in FIG. 1, in which FIG. 7A is a diagram illustrating a preparation step, and FIG. 7B is a diagram illustrating an arrangement step and a bonding step.

FIGS. 8A and 8B are sectional views illustrating the manufacturing method of the physical quantity sensor illustrated in FIG. 1, in which FIG. 8A is a diagram illustrating a pressure adjustment step, and FIG. 8B is a diagram illustrating a sealing step.

FIG. 9 is an enlarged sectional view illustrating a second embodiment of the physical quantity sensor of the invention.

FIGS. 10A and 10B are sectional views illustrating a manufacturing method of the physical quantity sensor illustrated in FIG. 9, in which FIG. 10A is a diagram illustrating a pressure adjustment step, and FIG. 10B is a diagram illustrating a sealing step.

FIG. 11 is an enlarged sectional view illustrating a third embodiment of the physical quantity sensor of the invention.

FIG. 12 is a perspective view illustrating a configuration of a mobile (or a note-type) personal computer to which an electronic device including the physical quantity sensor of the invention is applied.

FIG. 13 is a perspective view illustrating a configuration of a mobile phone (also including PHS) to which an electronic device including the physical quantity sensor of the invention is applied.

FIG. 14 is a perspective view illustrating a configuration of a digital still camera to which an electronic device including the physical quantity sensor of the invention is applied.

FIG. 15 is a perspective view illustrating a configuration of an automobile to which a moving object including the physical quantity sensor of the invention is applied.

### DESCRIPTION OF EXEMPLARY EMBODIMENTS

Hereinafter, a physical quantity sensor, an electronic device, and a moving object of the invention will be described in detail on the basis of preferred embodiments illustrated in the attached drawings.

First, a physical quantity sensor of the invention will be described.

### 1. Physical Quantity Sensor

### First Embodiment

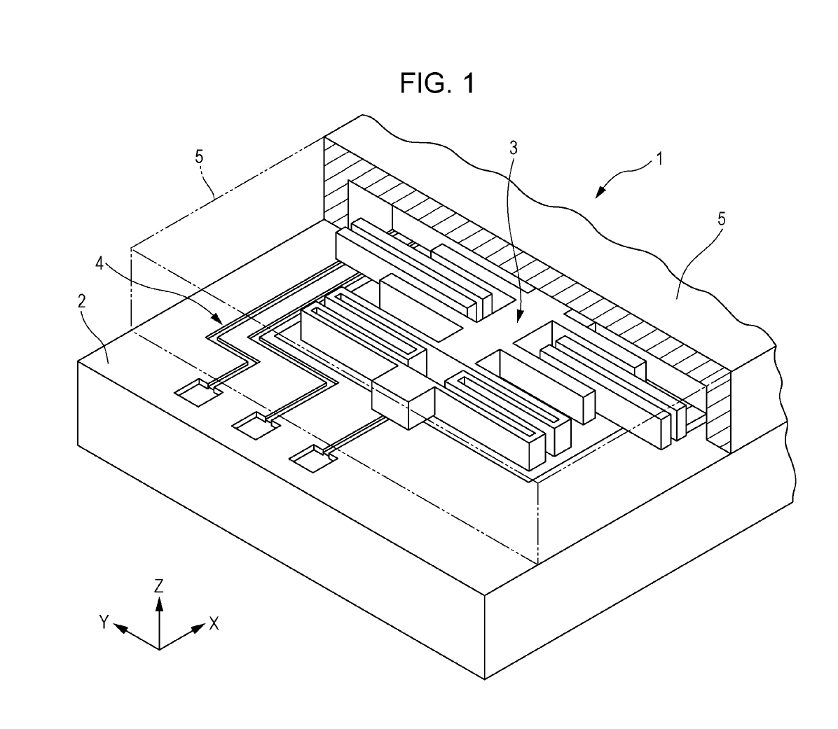

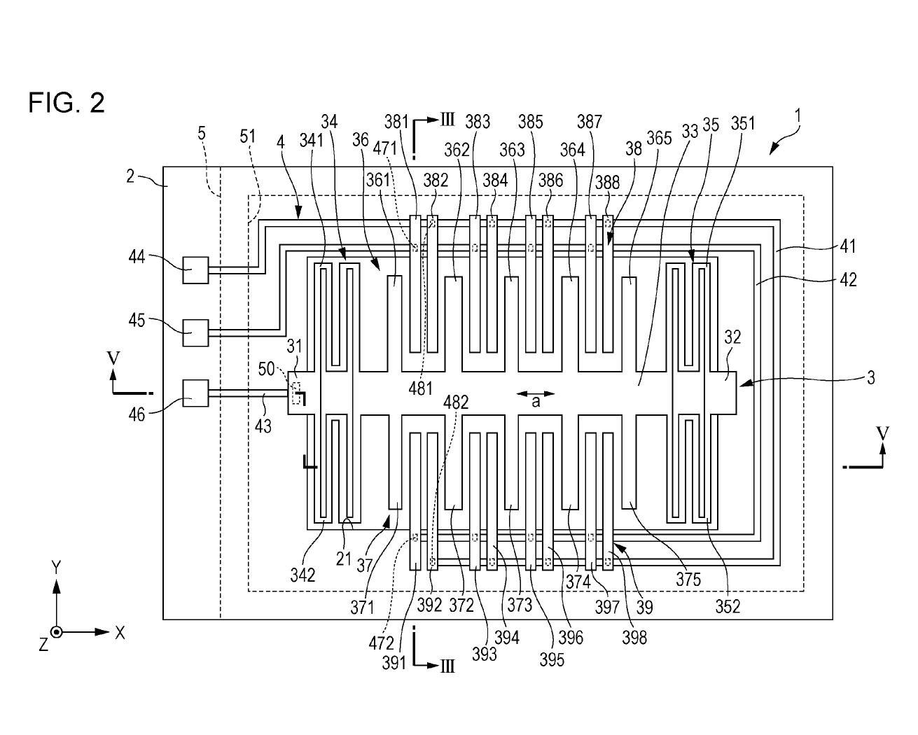

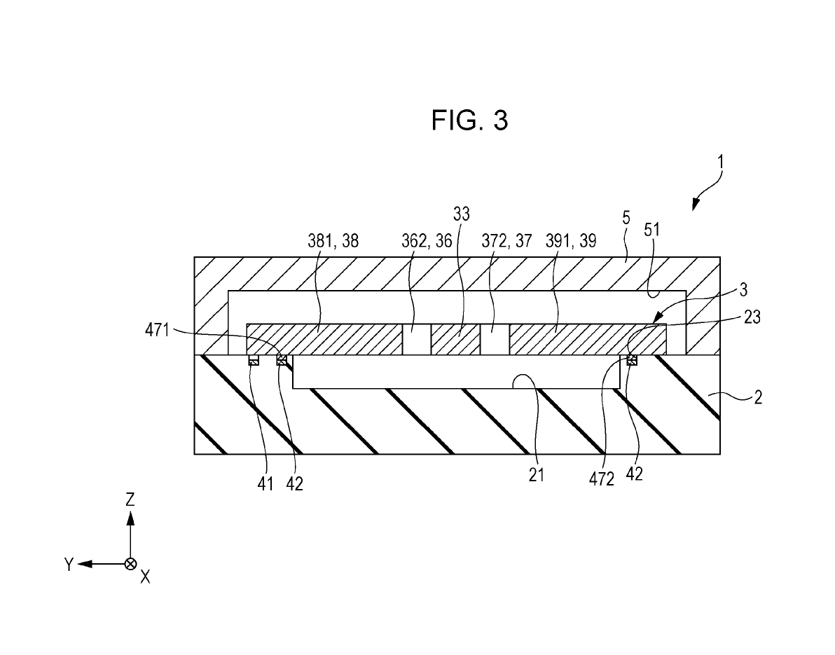

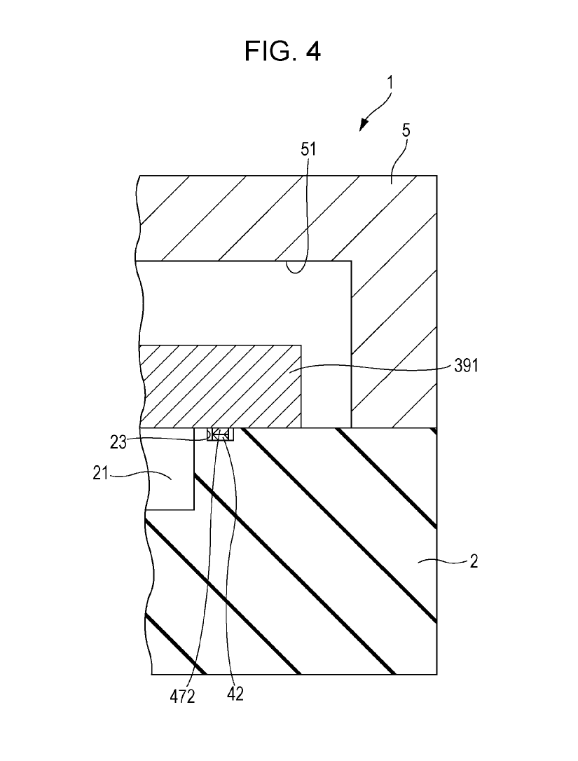

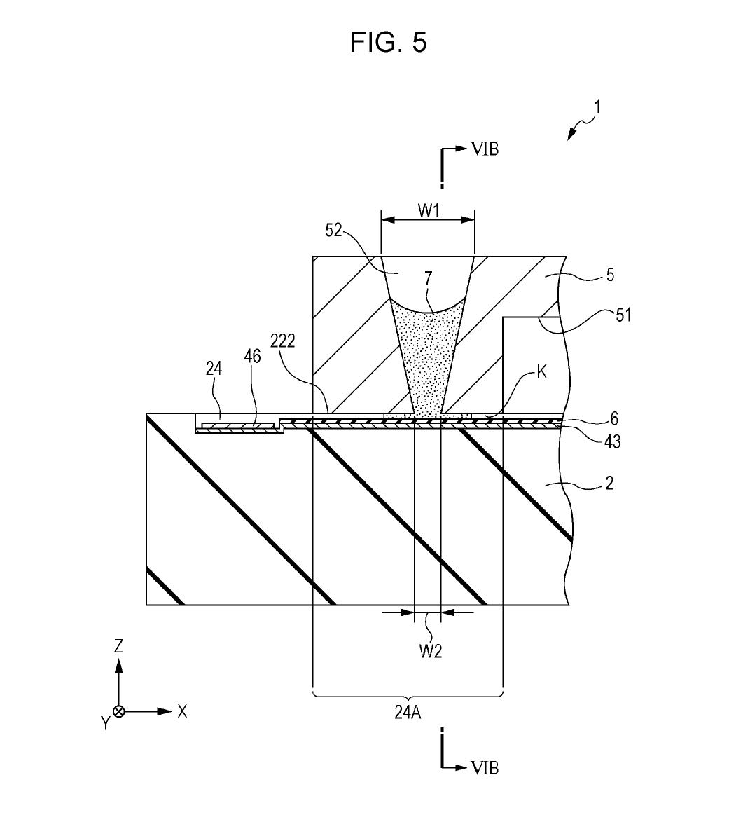

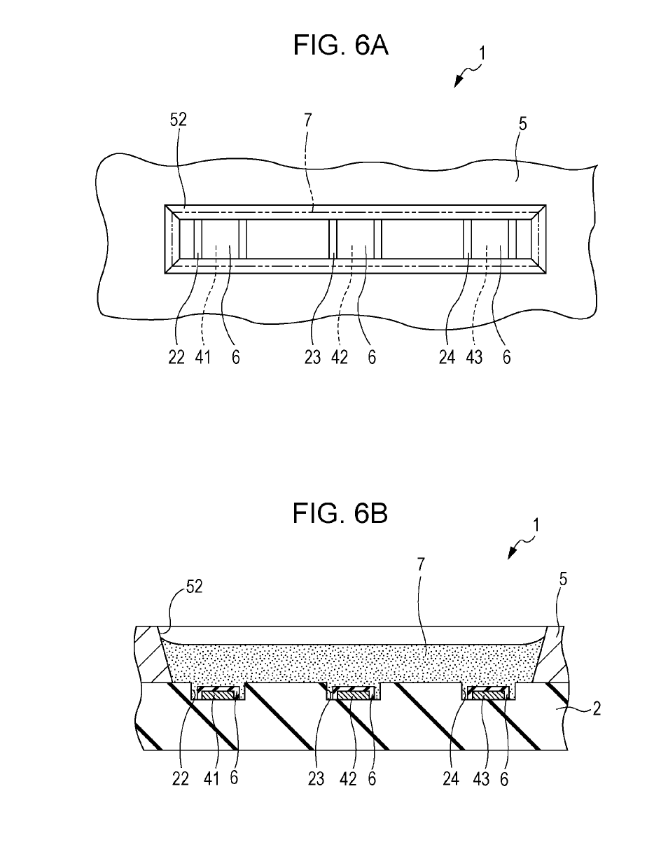

FIG. 1 is a perspective view illustrating a first embodiment of a physical quantity sensor of the invention. FIG. 2 is a plan view illustrating the physical quantity sensor illustrated in FIG. 1. FIG. 3 is a sectional view cut along line III-III of FIG. 2. FIG. 4 is a partially enlarged view (an enlarged sectional view) of FIG. 3. FIG. 5 is a partially enlarged view of a sectional view cut along line V-V of FIG. 2. FIG. 6A is a top view of a through hole, and FIG. 6B is a sectional view cut along line VIB-VIB of FIG. 5.

Furthermore, hereinafter, for the sake of convenience of description, in FIG. 2, a front side of the paper surface indicates “Up”, a deep side of the paper surface indicates “Down”, a right side indicates “Right”, and a left side indicates “Left”. In addition, in FIGS. 1 to 3 and 5, an X axis, a Y axis, and a Z axis are illustrated as three axes orthogonal to each other. In addition, hereinafter, a direction parallel to the X axis (a horizontal direction) indicates an “X axis direction”, a direction parallel to the Y axis indicates a “Y axis direction”, and a direction parallel to the Z axis (a vertical direction) indicates a “Z axis direction”. In addition, in the X axis, the Y axis, and the Z axis indicated by arrows, a direction indicated by the arrow is set to “+”, and an opposite direction thereof is set to “−”.

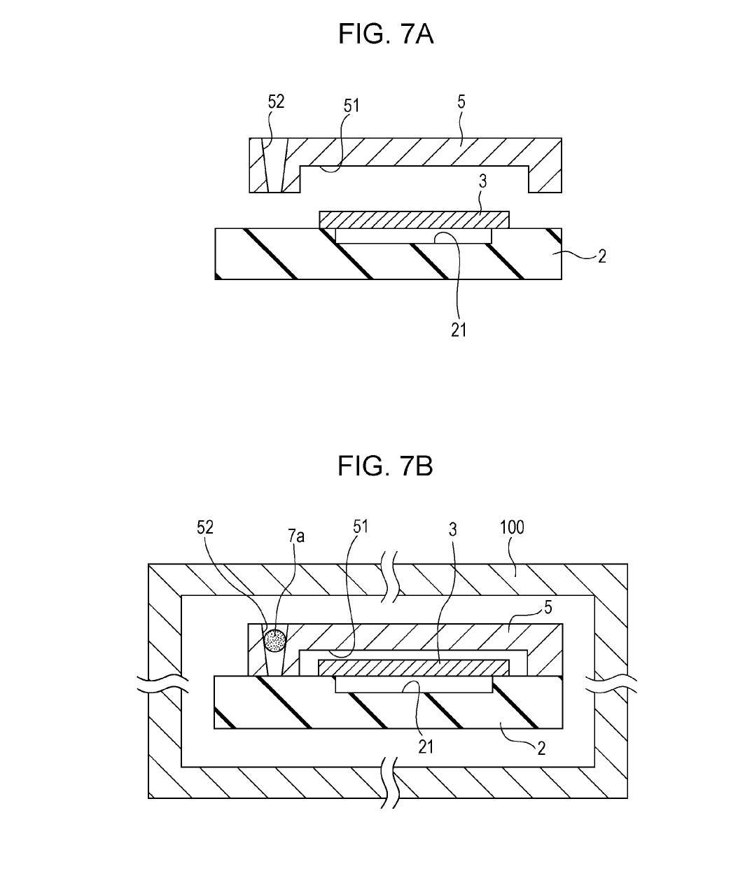

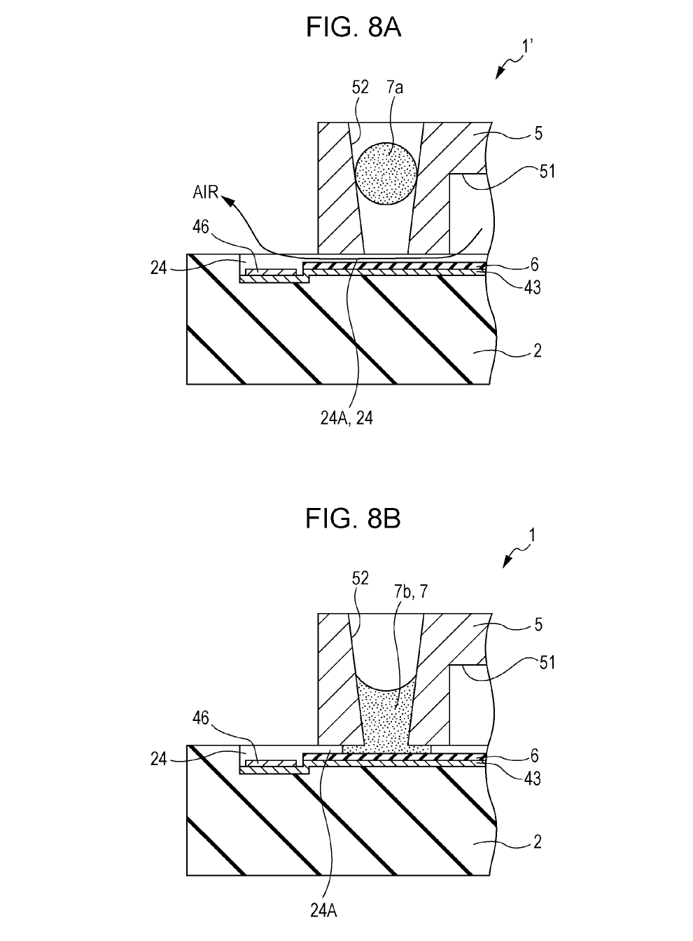

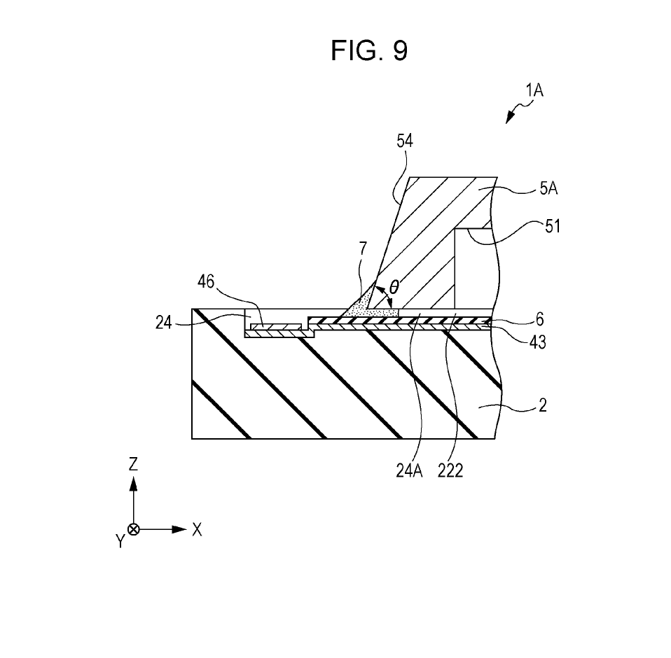

In addition, in FIGS. 7A and 7B and FIGS. 8A and 8B (the same applies to FIG. 9), the physical quantity sensor in a thickness direction is exaggeratingly illustrated, and the dimensions are largely different from the actual dimensions.

A physical quantity sensor 1 illustrated in FIG. 1 includes a support substrate 2, an element piece (a sensor element) 3 bonded to and supported on the support substrate 2, a conductor pattern 4 electrically connected to the element piece 3, and a lid substrate 5 disposed to cover the element piece 3.

Hereinafter, each portion configuring the physical quantity sensor 1 will be sequentially described in detail.

### Support Substrate

The support substrate 2 has a function of supporting the element piece 3.

The support substrate 2 has a plate-like shape, and a cavity portion 21 is disposed on an upper surface (one surface) thereof. In a plan view of the support substrate 2, the cavity portion 21 includes an inner bottom which is formed to include a movable portion 33, movable electrode portions 36 and 37, and connection portions 34 and 35 of the element piece 3 described below. Such a cavity portion 21 configures a relief portion which prevents the movable portion 33, the movable electrode portions 36 and 37, and the connection portions 34 and 35 of element piece 3 from being in contact with the support substrate 2. Accordingly, it is possible to allow displacement of the movable portion 33 of the element piece 3.

Furthermore, the relief portion may be an opening portion passing through the support substrate 2 in the thickness direction instead of the cavity portion 21 (a concave portion). In addition, in this embodiment, the cavity portion 21 has a quadrangular shape (specifically, a rectangular shape) in a plan view, but the shape of the cavity portion 21 is not limited thereto.

In addition, in the upper surface of the support substrate 2, concave portions 22, 23, and 24 are disposed on an outer side of the cavity portion 21 described above along the outer circumference of the cavity portion 21. The concave portions 22, 23, and 24 have shapes corresponding to the conductor pattern 4 in a plan view. Specifically, the concave portion 22 has a shape corresponding to wiring 41 and an electrode 44 of the conductor pattern 4 described below, the concave portion 23 has a shape corresponding to wiring 42 and an electrode 45 of the conductor pattern 4 described below, and the concave portion 24 has a shape corresponding to wiring 43 and an electrode 46 of the conductor pattern 4 described below.

In addition, the depth of a portion of the concave portion 22 in which the electrode 44 is disposed is deeper than the depth of a portion of the concave portion 22 in which the wiring 41 is disposed. Similarly, the depth of a portion of the concave portion 23 in which the electrode 45 is disposed is deeper than the depth of a portion of the concave portion 23 in which the wiring 42 is disposed. In addition, the depth of a portion of the concave portion 24 in which the electrode 46 is disposed is deeper than the depth of a portion of the concave portion 24 in which the wiring 43 is disposed.

By making the depth of a part of the concave portions 22, 23, and 24 deeper, it is possible to prevent a substrate 103 from being bonded to the electrodes 44, 45, and 46 at the time of bonding the substrate 103 before forming the element piece 3 to a substrate 102A in the manufacturing of the physical quantity sensor 1. Alternatively, when a corresponding portion on a surface of the substrate 103 to which the substrate 102A is bonded is removed by etching in a certain amount, the same effect is also able to be obtained.

As a configuration material of such a support substrate 2, specifically, it is preferable that a silicon material and glass material having high resistance are used, and in particular, when the element piece 3 is configured by using the silicon material as a main material, it is preferable that a glass material (for example, borosilicate glass such as Pyrex glass (registered trademark)) including alkali metal ions (movable ions) is used. Accordingly, when the element piece 3 is configured by using silicon as a main material, it is possible to perform anode bonding with respect to the support substrate 2 and the element piece 3.

In addition, a melting point or a softening point T2 (hereinafter, simply referred to as a “melting point”) of the support substrate 2 is not particularly limited, and for example, is higher than or equal to 450° C.

In addition, it is preferable that a difference in thermal expansion coefficients between the configuration material of the support substrate 2 and the configuration material of the element piece 3 is minimized, and specifically, it is preferable that the difference in the thermal expansion coefficients of the configuration material of the support substrate 2 and the configuration material of the element piece 3 is less than or equal to 3 ppm/° C. Accordingly, even when the support substrate 2 is bonded to the element piece 3 under a high temperature, it is possible to reduce residual stress between the support substrate 2 and the element piece 3.

### Element Piece

The element piece 3 is configured of fixed portions 31 and 32, the movable portion 33, the connection portions and 35, the movable electrode portions 36 and 37, and fixed electrode portions 38 and 39.

In such an element piece 3, for example, the movable portion 33 and the movable electrode portions 36 and 37 are displaced in the X axis direction (a +X direction or a −X direction) according to a change in a physical quantity such as acceleration and angular velocity while elastically deforming the connection portions 34 and 35.

The fixed portion 31 is bonded to a portion on the −X direction side (a left side in the drawing) with respect to the cavity portion 21 on the upper surface of the support substrate 2. The fixed portion 32 is bonded to a portion on the +X direction side (a right side in the drawing) with respect to the cavity portion 21 on the upper surface of the support substrate 2. In addition, each of the fixed portions 31 and 32 is disposed to cross the outer circumferential edge of the cavity portion 21 in a plan view.

The movable portion 33 is disposed between the fixed portions 31 and 32. In this embodiment, the movable portion 33 has an elongated shape extending in the X axis direction. The movable portion 33 is connected to the fixed portion 31 through the connection portion 34 and is connected to the fixed portion 32 through the connection portion 35.

The connection portions 34 and 35 displaceably connect the movable portion 33 to the fixed portions 31 and 32. In this embodiment, as illustrated in an arrow a of FIG. 2, the connection portions 34 and 35 are configured to displace the movable portion 33 in the X axis direction (the +X direction or the −X direction).

The connection portion 34 is configured of two beams 341 and 342. Then, each of the beams 341 and 342 has a shape extending in the X axis direction while meandering in the Y axis direction. In other words, each of the beams 341 and 342 has a shape folded back in the Y axis direction a plurality of times (in this embodiment, two times).

Similarly, the connection portion 35 is configured of two beams 351 and 352 which have a shape extending in the X axis direction while meandering in the Y axis direction.

Thus, the movable electrode portion 36 is disposed on one side (a +Y direction side) of the movable portion 33 in the width direction, which is displaceably supported with respect to the support substrate 2 in the X axis direction, and the movable electrode portion 37 is disposed on the other side (a −Y direction side).

The movable electrode portion 36 protrudes to the +Y direction from the movable portion 33, and include a plurality of movable electrode fingers 361 to 365 arranged to have a comb-like shape. The movable electrode fingers 361, 362, 363, 364, and 365 are arranged in sequence from the −X direction side to the +X direction side. Similarly, the movable electrode portion 37 protrudes in the −Y direction from the movable portion 33, and includes a plurality of movable electrode fingers 371 to 375 arranged to have a comb-like shape. The movable electrode fingers 371, 372, 373, 374, and 375 are arranged in sequence from the −X direction side to the +X direction side.

Thus, each of the plurality of movable electrode fingers 361 to 365 and each of the plurality of movable electrode fingers 371 to 375 are arranged in a direction in which the movable portion 33 is displaced (that is, the Y axis direction).

The fixed electrode portion 38 includes a plurality of fixed electrode fingers 381 to 388 arranged to have a comb-like shape which meshes with the plurality of movable electrode fingers 361 to 365 of the movable electrode portion 36 described above at set intervals. Each end portion of the plurality of fixed electrode fingers 381 to 388 on a side opposite to the movable portion 33 is bonded to a portion on the +Y direction side with respect to the cavity portion 21 on the upper surface of the support substrate 2. Then, in each of the fixed electrode fingers 381 to 388, an end on a fixed side is set to a fixed end, and a free end extends in the −Y direction.

The fixed electrode fingers 381 to 388 are arranged in sequence from the −X direction side to the +X direction side. Then, the fixed electrode fingers 381 and 382 are paired with each other and are disposed to respectively face the movable electrode fingers 361 and 362 described above, the fixed electrode fingers 383 and 384 are paired with each other and are disposed to respectively face the movable electrode fingers 362 and 363, the fixed electrode fingers 385 and 386 are paired with each other and are disposed to respectively face the movable electrode fingers 363 and 364, and the fixed electrode fingers 387 and 388 are paired with each other and are disposed to respectively face the movable electrode fingers 364 and 365.

On the support substrate 2, the fixed electrode fingers 382, 384, 386, and 388 are isolated from the fixed electrode fingers 381, 383, 385, and 387 in the shape of an island without being connected to each other. Accordingly, electrostatic capacitance between the fixed electrode fingers 382, 384, 386, and 388 and the movable electrode portion 36, and electrostatic capacitance between the fixed electrode fingers 381, 383, 385, and 387 and the movable electrode portion 36 are separately measured, and the physical quantity is able to be detected with high accuracy on the basis of the measurement result thereof.

The fixed electrode portion 39 includes a plurality of fixed electrode fingers 391 to 398 arranged to have a comb-like shape which meshes with the plurality of movable electrode fingers 371 to 375 of the movable electrode portion 37 described above at set intervals. Each end portion of the plurality of fixed electrode fingers 391 to 398 on a side opposite to the movable portion 33 is bonded to a portion on the −Y direction side with respect to the cavity portion 21 on the upper surface of the support substrate 2. Then, in each of the fixed electrode fingers 391 to 398, an end on a fixed side is set to a fixed end, and a free end extends in the +Y direction.

The fixed electrode fingers 391, 392, 393, 394, 395, 396, 397, and 398 are arranged in sequence from the −X direction side to the +X direction side. Then, the fixed electrode fingers 391 and 392 are paired with each other and are disposed to respectively face the movable electrode fingers 371 and 372, the fixed electrode fingers 393 and 394 are paired with each other and are disposed to respectively face the movable electrode fingers 372 and 373, the fixed electrode fingers 395 and 396 are paired with each other and are disposed to respectively face the movable electrode fingers 373 and 374, and the fixed electrode fingers 397 and 398 are paired with each other and are disposed to respectively face the movable electrode fingers 374 and 375.

On the support substrate 2, the fixed electrode fingers 392, 394, 396, and 398 are separated from the fixed electrode fingers 391, 393, 395, and 397, as with the fixed electrode portion 38 described above. Accordingly, electrostatic capacitance between the fixed electrode fingers 392, 394, 396, and 398 and the movable electrode portion 37, and electrostatic capacitance between the fixed electrode fingers 391, 393, 395, and 397 and the movable electrode portion 37 are separately measured, and the physical quantity is able to be detected with high accuracy on the basis of the measurement result thereof.

The element piece 3 (that is, the fixed portions 31 and 32, the movable portion 33, the connection portions 34 and 35, the plurality of fixed electrode fingers 381 to 388, 391 to 398, and the plurality of movable electrode fingers 361 to 365, and 371 to 375) is formed by etching one silicon substrate described below.

In addition, the configuration material of the element piece 3 is not particularly limited insofar as the physical quantity is able to be detected on the basis of a change in the electrostatic capacitance as described above, but a semiconductor is preferable as the configuration material, and in this embodiment, a silicon material such as single crystal silicon and polysilicon is used as the configuration material.

In addition, it is preferable that the silicon material configuring the element piece 3 is doped with impurities such as phosphorus and boron. Accordingly, it is possible to make conductivity of the element piece 3 excellent.

In addition, as described above, the fixed portions and 32 and the fixed electrode portions 38 and 39 are bonded to the upper surface of the support substrate 2, and thus the element piece 3 is supported on the support substrate 2.

A bonding method of the element piece 3 and the support substrate 2 is not particularly limited, and it is preferable that an anode bonding method is used. Accordingly, it is possible to strongly bond the element piece 3 to the support substrate 2.

### Conductor Pattern

The conductor pattern 4 is disposed on the upper surface of the support substrate 2 described above (the surface on the fixed electrode portions 38 and 39 side).

The conductor pattern 4 is configured of wirings 41, 42, and 43, and electrodes 44, 45, and 46.

The wiring 41 is disposed on the outer side of the cavity portion 21 of the support substrate 2 described above, and is formed along the outer circumference of the cavity portion 21. Then, one end portion of the wiring 41 is connected to the electrode 44 on an outer circumferential portion of the upper surface of the support substrate 2 (a portion on the outer side of the lid substrate 5 on the support substrate 2).

The wiring 41 is electrically connected to each of the fixed electrode fingers 382, 384, 386, and 388 and each of the fixed electrode fingers 392, 394, 396, and 398 which are first fixed electrode fingers of the element piece 3 described above.

In addition, the wiring 42 is disposed on the inner side of the wiring 41 described above and on the outer side of the cavity portion 21 of the support substrate 2 described above along the outer circumferential edge thereof. Then, one end portion of the wiring 42 is connected to the electrode 45 on the outer circumferential portion of the upper surface of the support substrate 2 (the portion on the outer side of the lid substrate 5 on the support substrate 2) to be arranged at set intervals with respect to the electrode 44 described above.

The wiring 43 is disposed to extend from a bonding portion on the support substrate 2 with respect to the fixed portion 31 onto the outer circumferential portion of the upper surface of the support substrate 2 (the portion on the outer side of the lid substrate 5 on the support substrate 2). The wiring 43 is connected to the fixed portion 31 through a projection 50. Then, an end portion of the wiring 43 on a side opposite to the fixed portion 31 is connected to the electrode 46 on the outer circumferential portion of the upper surface of the support substrate 2 (the portion on the outer side of the lid substrate 5 on the support substrate 2) to be arranged at set intervals with respect to the electrodes 44 and 45 described above.

In addition, the wiring 41 and the electrode 44 are disposed in the concave portion 22 of the support substrate 2 described above (a first concave portion), the wiring 42 and the electrode 45 are disposed in the concave portion 23 of the support substrate 2 described above (a second concave portion), and the wiring 43 and the electrode 46 are disposed on the concave portion 24 of the support substrate 2 described above (a third concave portion). Accordingly, it is possible to prevent the wirings 41 to 43 from protruding from the plate surface of the support substrate 2.

A plurality of projections 481 and a plurality of projections 482 having conductivity are disposed on the wiring 41. The plurality of projections 481 are disposed corresponding to the fixed electrode fingers 382, 384, 386, and 388 which are a plurality of first fixed electrode fingers, and the plurality of projections 482 are disposed corresponding to the fixed electrode fingers 392, 394, 396, and 398 which are a plurality of first fixed electrode fingers.

Then, the fixed electrode fingers 382, 384, 386, and 388 are electrically connected to the wiring 41 through the plurality of projections 481, and the fixed electrode fingers 392, 394, 396, and 398 are electrically connected to the wiring 41 through the plurality of projections 482.

Similarly, a plurality of projections 471 and a plurality of projections 472 having conductivity are disposed on the wiring 42. The plurality of projections 471 are disposed corresponding to the fixed electrode fingers 381, 383, 385, and 387 which are a plurality of second fixed electrode fingers, and the plurality of projections 472 are disposed corresponding to the fixed electrode fingers 391, 393, 395, and 397 which are a plurality of second fixed electrode fingers.

Then, the fixed electrode fingers 381, 383, 385, and 387 are electrically connected to the wiring 42 through the plurality of projections 471, and the fixed electrode fingers 391, 393, 395, and 397 are electrically connected to the wiring 42 through the plurality of projections 472.

Accordingly, each of the fixed electrode fingers 381, 383, 385, 387, 391, 393, 395, and 397 is able to be electrically connected to the wiring 42 while preventing the wiring 42 from being undesirably electrically connected (short-circuited) to other portions.

The configuration material of the wirings 41 to 43 and the electrodes 44 to 46 is not particularly limited insofar as the configuration has conductivity, various electrode materials are able to be used as the configuration material, examples of the configuration material include an oxide such as Indium Tin Oxide (ITO), Indium Zinc Oxide (IZO), In₃O₃, SnO₂, Sb-containing SnO₂, and Al-containing ZnO (a transparent electrode material), Au, Pt, Ag, Cu, Al, an alloy thereof, and the like, and among them, one type is able to be used, or two or more types are able to be used in combination.

Such a conductor pattern 4 is disposed on the upper surface of the support substrate 2, and thus the electrostatic capacitance between the fixed electrode fingers 382, 384, 386, and 388 and the movable electrode portion 36, and the electrostatic capacitance between the fixed electrode fingers 392, 394, 396, and 398 and the movable electrode portion 37 are able to be measured through the wiring 41, the electrostatic capacitance between the fixed electrode fingers 381, 383, 385, and 387 and the movable electrode portion 36, and the electrostatic capacitance between the fixed electrode fingers 391, 393, 395, and 397 and the movable electrode portion 37 are able to be measured through the wiring 42. In addition, in this embodiment, the wiring 43 functions as wiring for a ground.

### Insulating Film

In addition, as illustrated in FIGS. 4, 6A and 6B, an insulating film 6 is disposed on the wirings 41 to 43. Then, the insulating film 6 is not formed on each of the projections 471, 472, 481, and 482 described above, but the surface of the projection is exposed. The insulating film 6 has a function of preventing the conductor pattern 4 from being undesirably electrically connected (short-circuited) to the element piece 3. Accordingly, each of the first fixed electrode fingers 382, 384, 386, 388, 392, 394, 396, and 398 is able to be electrically connected to the wiring 41 and each of the second fixed electrode fingers 381, 383, 385, 385, 387, 391, 393, 395, and 397 is able to be electrically connected to the wiring 42 while more reliably preventing the wirings 41 and 42 from being undesirably electrically connected (short-circuited) to the other portion. In addition, the fixed portion 31 is able to be electrically connected to the wiring 43 while more reliably preventing the wiring 43 from being undesirably electrically connected (short-circuited) to the other portion.

In addition, a gap is formed between the fixed electrode finger 391 and the insulating film 6 on the wiring 41. Even though it is not illustrated, a gap identical to the gap described above is also formed between each of the other fixed electrode fingers and the insulating film 6 on the wirings 41 and 42.

In addition, as illustrated in FIGS. 6A and 6B, a gap 222 is formed between the lid substrate 5 and the insulating film 6 on the wiring 43. Even though it is not illustrated, a gap 222 identical to the gap described above is also formed between the lid substrate 5 and the insulating film 6 on the wirings 41 and 42. The gap is able to be used for decompressing the inside of the lid substrate or for filling the inside of the lid substrate 5 with inert gas.

The configuration material of the insulating film 6 is not particularly limited, but various materials having insulation properties are able to be used, and when the support substrate 2 is configured of a glass material (in particular, a glass material to which alkali metal ions are added), it is preferable that silicon dioxide (SiO₂) is used. Accordingly, it is possible to prevent undesirable electrical connection as described above, and even when the insulating film 6 exists in the bonding portion on the upper surface of the support substrate 2 with respect to the element piece 3, it is possible to perform anode bonding with respect to the support substrate 2 and the element piece 3.

In addition, the thickness of the insulating film 6 (the average thickness) is not particularly limited, but is preferably approximately 10 nm to 1000 nm, and is more preferably approximately 10 nm to 200 nm. When the insulating film 6 is formed to have a thickness of this range, it is possible to prevent undesirable electrical connection as described above.

### Lid Substrate

The lid substrate 5 has a function of protecting the element piece 3 described above.

The lid substrate 5 has a plate-like shape, and a concave portion 51 is disposed on one surface (a lower surface) thereof. The concave portion 51 is formed to allow displacement of the movable portion 33 and the movable electrode portions 36 and 37 of the element piece 3.

Then, a portion on the lower surface of the lid substrate 5, which is on the further outer side than the concave portion 51, is bonded to the upper surface of the support substrate 2 described above. In this embodiment, the support substrate 2 is bonded to the lid substrate 5 through the insulating film 6 described above.

In addition, as illustrated in FIG. 5 and FIGS. 6A and 6B, on the −X side from the concave portion 51 of the lid substrate 5, a through hole 52 passing through the support substrate 2 in the thickness direction is disposed. The through hole 52 has a rectangular shape extending in the Y axis direction when seen from the Z axis direction.

In addition, as illustrated in FIGS. 6A and 6B, the through hole 52 is disposed on a portion corresponding to the concave portions 22 to 24, and specifically, intersects each of the concave portions 22 to 24 when seen from the Z axis direction. Accordingly, each of the concave portions 22 to 24 is able to be filled with the sealing material 7 through one through hole 52. Accordingly, the lid substrate 5 is able to be easily formed, compared to a case where each of three through holes is formed with respect to the concave portions 22 to 24.

In addition, the width of the through hole 52 (the length in the X axis direction) gradually decreases when becoming closer to the support substrate 2 side. A ratio W1/W2 of width W1 of an upper surface opening of the through hole 52 to a width W2 of a lower surface opening of the through hole 52 is preferably greater than or equal to 10 and less than or equal to 70, and is more preferably greater than or equal to 15 and less than or equal to 30. Accordingly, as described below, a rod-like sealing material 7a is able to be stably arranged in the through hole 52.

In addition, a melting point (a softening point) T5 of the lid substrate 5 is not particularly limited, and for example, is preferably higher than or equal to 1000° C., and is more preferably higher than or equal to 1100° C.

A bonding method of the lid substrate 5 and the support substrate 2 is not particularly limited, and examples of the bonding method include a bonding method using an adhesive agent, an anode bonding method, a direct bonding method, and the like.

In addition, the configuration material of the lid substrate 5 is not particularly limited insofar as the configuration material is able to exhibit the functions as described above, and for example, a silicon material, a glass material, and the like are able to be preferably used as the configuration material.

### Sealing Material

As illustrated in FIG. 5 to FIGS. 7A and 7B, the concave portions 22 to 24 which intersects (crosses) a boundary portion between the support substrate 2 and the lid substrate 5, and the through hole 52 are filled with the sealing material 7 when seen from the Y axis direction. Herein, the “boundary portion K” indicates a bonding surface onto which the support substrate 2 and the lid substrate 5 are bonded.

Hereinafter, the concave portion 24 illustrated in FIG. 5 will be representatively described. Furthermore, the concave portions 22 and 23 are similarly filled with the sealing material 7. In addition, a portion intersecting the boundary portion K of the concave portion 24 is also referred to as a “concave portion 24A” when seen from the Z axis direction.

In the concave portion 24A, a portion overlapping the lower surface opening of the through hole 52 and a peripheral portion thereof (a portion on the +X side and a portion on the −X side) are filled with the sealing material 7 when seen from the Z axis direction. In addition, the sealing material 7 adheres to each of the inner surface of the concave portion 24A, the insulating film 6, and the lower surface of the lid substrate 5.

In addition, the through hole 52 is filled with the sealing material 7 from the lower surface opening of the through hole 52 to the middle of the depth direction, and the sealing material 7 adheres to the inner surface of the through hole 52 over the entire circumference.

According to the configuration described above, in the physical quantity sensor 1, the concave portion 24A and the through hole 52 are sealed (closed) with the sealing material 7, and thus the concave portion 51 is airtightly sealed.

Here, in the physical quantity sensor 1, for example, when a portion of the concave portion 24A on the +X side from the lower surface opening of the through hole 52 is filled with the sealing material 7, the concave portion 51 is able to be airtightly sealed. In this embodiment, not only the portion of the concave portion 24A on the +X side from the lower surface opening of the through hole 52, but also a portion directly below the lower surface opening of the through hole 52 and a portion on the −X side thereof are filled with the sealing material 7. Accordingly, it is possible to make airtightness of the concave portion 51 excellent. Accordingly, it is possible to increase reliability of the physical quantity sensor 1.

Further, in the physical quantity sensor 1, the through hole 52 is also filled with the sealing material 7 to the middle of the depth direction, and according to this, it is possible to further increase the airtightness of the concave portion 51. Accordingly, it is possible to further increase the reliability of the physical quantity sensor 1.

Thus, the sealing material 7 is arranged not only in the concave portions 22 to 24 but also in the through hole 52. Accordingly, as in a manufacturing method of the physical quantity sensor 1 described below, the concave portion 24A is able to be easily filled with the sealing material 7 through the through hole 52. Accordingly, the concave portion 51 is able to be more easily sealed.

In addition, as described above, in the physical quantity sensor 1, the through hole 52 intersects each of the concave portions 22 to 24. Accordingly, the concave portion 22 to the concave portion 24 are collectively sealed with one sealing material 7. Accordingly, the concave portion 51 is able to be easily and airtightly sealed.

In addition, a melting point T7 of the sealing material 7 is lower than the melting point T2 of the support substrate 2 and the melting point T5 of the lid substrate 5. Accordingly, in a sealing step described below, when the sealing material 7 is melted, it is possible to prevent thermal deformation of the support substrate 2 and the lid substrate 5.

A difference ΔT between the melting point T7 of the sealing material 7 and the melting point T2 of the support substrate 2 or the melting point T5 of the lid substrate 5 is preferably higher than or equal to 20° C., and is more preferably higher than or equal to 100° C. Accordingly, the concave portion 51 is able to be effectively sealed.

When the difference ΔT is excessively small, in a bonding step described below, and when a heating time (a bonding time) is comparatively long, the sealing material 7 is likely to be melted.

The melting point T7 of the sealing material 7 is not particularly limited insofar as the melting point T7 satisfies the relationship as described above, and for example, is preferably higher than or equal to 320° C. and lower than or equal to 450° C., and is more preferably higher than or equal to 340° C. and lower than or equal to 430° C.

The configuration material of the sealing material is not particularly limited, and for example, a metal material such as a Au—Ge-based alloy or a Au—Sn-based alloy, a glass material having a low melting point such as lead glass, bismuth-based glass, and vanadium-based glass, and the like are able to be used as the configuration material. Accordingly, the configuration material of the sealing material 7 satisfying a condition in which the melting point of the configuration material is lower than the melting point T2 of the support substrate 2 and the melting point T5 of the lid substrate 5 is easily selected.

Here, the wirings 41 to 43 are covered with the insulating film 6. Accordingly, even when a material having conductivity such as a metal material is used as the sealing material 7, it is possible to prevent the wirings 41 to 43 from being short-circuited.

When the sealing material 7 is configured of a glass material having a low melting point as described above, the sealing material 7 has insulation properties. Accordingly, even when the insulating film 6 is omitted, it is possible to prevent the wirings 41 to 43 from being short-circuited. Further, when the support substrate 2 or the lid substrate 5 is configured of a glass material, it is possible to increase affinity with respect to the inner surface of the through hole and the inner surface of the concave portions 22 to 24. Accordingly, it is possible to further increase the airtightness of the concave portion 51.

As described above, in the physical quantity sensor 1, the wirings 41 to 43 are arranged in the concave portions to 24 formed on the support substrate 2, and thus the wirings 41 to 43 are able to be derived into the outer side of the lid substrate 5. In addition, according to such a configuration, it is possible to airtightly bond the upper surface of the support substrate 2 to the lower surface of the lid substrate 5 by using the flatness thereof. Further, the concave portions 22 to 24 positioned in the boundary portion K between the support substrate 2 and the lid substrate 5 are locally sealed, and thus the concave portion 51 is able to be airtightly sealed. Therefore, according to the invention, even when the wirings 41 to 43 are derived into the outer side of the lid substrate 5, the concave portion 51 is able to be easily and airtightly sealed.

### Manufacturing Method of Physical Quantity Sensor

Next, a manufacturing method of the physical quantity sensor 1 will be described.

FIGS. 7A and 7B are sectional views illustrating a manufacturing method of the physical quantity sensor illustrated in FIG. 1, in which FIG. 7A is a diagram illustrating a preparation step, and FIG. 7B is a diagram illustrating an arrangement step and a bonding step. FIGS. 8A and 8B are sectional views illustrating the manufacturing method of the physical quantity sensor illustrated FIG. 1, in which FIG. 8A is a diagram illustrating a pressure adjustment step, and FIG. 8B is a diagram illustrating a sealing step.

The manufacturing method of the physical quantity sensor includes (1) Preparation Step, (2) Arrangement Step, (3) Bonding Step, (4) Pressure Adjustment Step, and (5) Sealing Step.

Furthermore, a chamber 100 is illustrated only in FIG. 7B but is not illustrated in FIGS. 8A and 8B, and in this embodiment, (3) Bonding Step to (5) Sealing Step are performed in the chamber 100 until the steps are completed.

In addition, hereinafter, a case where the support substrate 2 is configured of a glass material including alkali metal ions, and the lid substrate 5 is configured of a silicon material will be described as an example.

In addition, the element piece 3 is able to be formed by a known method, and thus the description thereof will be omitted.

### (1) Preparation Step

First, as illustrated in FIG. 7A, the support substrate 2 in which the element piece 3 is disposed on the upper surface, and the lid substrate 5 are prepared.

Furthermore, the cavity portion 21 and the concave portions 22 to 24 of the support substrate 2, and the concave portion 51 and the through hole 52 of the lid substrate 5 are formed by etching.

An etching method is not particularly limited, and for example, one type of a physical etching method such as plasma etching, reactive ion etching, beam etching, and optical assist etching, and a chemical etching method such as wet etching is able to be used or two or more types thereof are able to be used in combination as the etching method.

### (2) Arrangement Step

Subsequently, as illustrated in FIG. 7B, the rod-like sealing material 7a formed of the sealing material 7 is arranged in the through hole 52. The outer diameter of the sealing material 7a (the maximum outer diameter) is larger than the width of the lower surface opening of the through hole 52, and is smaller than the width of the upper surface opening of the through hole 52. Accordingly, the sealing material 7a is able to be arranged in the through hole 52 (hereinafter, this state is referred to as an “arrangement state”).

In addition, as described above, the width of the through hole 52 gradually decreases when becoming closer to the lower side. Accordingly, in the arrangement state, the sealing material 7a remains in a portion coincident with the width of the through hole 52. Accordingly, the sealing material 7a in the through hole 52 is prevented from being moved in the Z axis direction. Further, the sealing material 7a remains in a portion coincident with the hole diameter of the through hole 52, and thus it is possible to also prevent the sealing material 7a from being moved in an XY plane direction. Accordingly, it is possible to more stably arrange the sealing material 7a in the through hole 52.

### (3) Bonding Step

Subsequently, as illustrated in FIG. 7B, the lid substrate 5 is arranged on the upper surface of the support substrate 2 such that the element piece 3 is contained in the concave portion 51 (hereinafter, this state is referred to as a “physical quantity sensor 1′”). Then, the physical quantity sensor 1′ is put into the chamber 100. Furthermore, the sealing material 7a may be arranged in the through hole after the lid substrate 5 is arranged on the upper surface of the support substrate 2.

Then, the upper surface of the support substrate 2 is bonded to the lower surface of the lid substrate 5 by anode bonding. Accordingly, it is possible to bond the support substrate 2 to the lid substrate 5 with high strength and airtightness.

The temperature of the chamber 100 in the anode bonding, that is, a temperature Ta of the physical quantity sensor 1′ at the time of performing the anode bonding is not particularly limited insofar as the temperature Ta is lower than the melting point T7 of the sealing material 7a, but is preferably higher than or equal to 150° C. and lower than or equal to 380° C., and is more preferably higher than or equal to 250° C. and lower than or equal to 360° C. Accordingly, even when the anode bonding is performed in the arrangement state, the sealing material 7a is melted, and thus it is possible to prevent the concave portion 51 from being sealed.

Furthermore, in the bonding step, when the temperature Ta is excessively low, bonding strength between the support substrate 2 and the lid substrate 5 may be insufficient. In addition, when the temperature Ta is excessively high, the sealing material 7a is softened, and thus the concave portion 51 may be sealed.

Furthermore, in a state where the bonding step is completed, the concave portion 51 is communicated with the outer side through the through hole 52 and the concave portions 22 to 24.

### (4) Pressure Adjustment Step

Subsequently, as illustrated in FIG. 8A, the chamber 100 is evacuated by using a vacuum pump. At this time, as illustrated by an arrow of FIG. 8A, the air of the concave portion 51 is discharged to the outer side of the concave portion 51 through the concave portions 22 to 24. Accordingly, the concave portion 51 is in a vacuum state. Furthermore, herein, the “vacuum state” indicates a state where the atmospheric pressure is less than or equal to 10 Pa.

First, the concave portion 51 is in the vacuum state, and then, for example, inert gas such as nitrogen, argon, helium, and neon, air, and the like are injected into the chamber 100, and thus the atmospheric pressure in the chamber 100 is in a barometric pressure state. Accordingly, as illustrated by an arrow of FIG. 8A, air (inert gas) flows into the concave portion 51 through a fine gap between the sealing material 7a and the inner surface of the through hole 52, and thus the concave portion 51 is in the barometric pressure state.

Furthermore, in this embodiment, the concave portion 51 is in the barometric pressure state in the pressure adjustment step, and a case where the concave portion 51 after the pressure adjustment step is in a reduced pressure state in which the atmospheric pressure is lower than the barometric pressure is included in the invention. In the reduced pressure state, the atmospheric pressure is preferably greater than or equal to 0.3×10⁵ Pa and less than or equal to 1×10⁵ Pa, and is more preferably greater than or equal to 0.5×10⁵ Pa and less than or equal to 0.8×10⁵ Pa. When the concave portion 51 is sealed in such a reduced pressure state, suitable damping (damping force of vibration) acts on the element piece 3 at the time of driving, as a result thereof, it is possible to prevent unnecessary vibration from occurring. Accordingly, it is possible to increase detection sensitivity of the element piece 3 as an acceleration sensor.

### (5) Sealing Step

Subsequently, as illustrated in FIG. 8B, the chamber 100 is heated while maintaining the pressure state in the chamber 100 to the pressure state after (4) Pressure Adjustment Step, the temperature of the chamber 100 is set to a temperature Tb which is higher than or equal to the melting point T7 of the sealing material 7a and lower than the melting point T2 of the support substrate 2 and the melting point T5 of the lid substrate 5, and the sealing material 7a is melted in the through hole 52. Accordingly, the sealing material 7a which is in a liquid state due to the melting (hereinafter, the sealing material 7a in the liquid state is referred to as a “sealing material 7b”) adheres to the inner surface of the through hole 52 over the entire circumference, and adheres to the inner surface of the concave portion 24A (the same applies to the concave portions 22 and 23) and the upper surface of the insulating film 6 from the lower surface opening of the through hole 52. Accordingly, a space in the concave portion 51 is separated from a space on the outer side of the concave portion 51 by the sealing material 7b. As a result thereof, the concave portion 51 is airtightly sealed.

In addition, the viscosity of the sealing material 7b depends on the width of the lower surface opening of the through hole 52, but is not particularly limited insofar as the sealing material 7b is able to flow into the concave portions 22 to 24 from the lower surface opening of the through hole 52. Specifically, the viscosity of the sealing material 7b is preferably greater than or equal to 0.5×10³ Pa·s and is less than or equal to 10×10⁻³ Pa·s, and is more preferably greater than or equal to 2×10⁻³ Pa·s and less than or equal to 5×10³ Pa·s.

When the viscosity of the sealing material 7b is excessively low, the amount of sealing material 7b which flows into the concave portions 22 to 24 from the through hole 52 increases, and thus the amount of the sealing material 7b with which the through hole 52 is filled decreases, or the through hole 52 tends to be insufficiently sealed. In contrast, when the viscosity of the sealing material 7b is excessively high, it is difficult for the sealing material 7b to flow into the concave portions 22 to 24 from the lower surface opening of the through hole 52, and the concave portions 22 to 24 may be insufficiently sealed.

Then, after (5) Sealing Step is completed, finally, the sealing material 7b is coagulated, for example, by returning the temperature to the ordinary temperature. Accordingly, it is possible to obtain the physical quantity sensor 1.

Thus, the concave portion 51 is able to be airtightly sealed through steps (1) to (5). In particular, the melting point T7 of the sealing material 7a is lower than the melting point T2 of the support substrate 2 and the melting point T5 of the lid substrate 5, and thus in the bonding step, it is possible to prevent the support substrate 2 and the lid substrate 5 from being thermally deformed. Accordingly, it is possible to obtain the physical quantity sensor 1 with excellent dimensional accuracy.

In addition, when the physical quantity sensor 1′ is put into the chamber 100, it is possible to perform (3) Bonding Step to (5) Sealing Step without putting in the physical quantity sensor 1′ or taking out the physical quantity sensor 1′ from the chamber 100. For this reason, this manufacturing method is extremely simple and has high productivity.

Furthermore, a plurality of physical quantity sensors 1′ are put into one chamber 100, and the steps (1) to (5) described above are performed, and thus it is possible to collectively obtain a plurality of physical quantity sensors 1.

### Second Embodiment

Next, a second embodiment of the physical quantity sensor of the invention will be described.

FIG. 9 is an enlarged sectional view illustrating a second embodiment of the physical quantity sensor of the invention.

Hereinafter, the second embodiment of the physical quantity sensor will be described with reference to the drawings focusing on differences with respect to the embodiment described above, and the description of the same configurations will be omitted.

The second embodiment is approximately identical to the first embodiment except that the arrangement position of the sealing material is different.

In a physical quantity sensor 1A illustrated in FIG. 9, a side surface 54 positioned on the −X side in the side surface of the lid substrate 5A is inclined with respect to an XY plane. An inclination angle θ is not particularly limited, and is preferably greater than or equal to 35° and less than or equal to 85°, and is more preferably greater than or equal to 45° and less than or equal to 75°.

When the inclination angle θ is excessively large, as described below, it is difficult to maintain a state where the sealing material 7 is in contact with the side surface 54, though it is due to the viscosity of the sealing material 7b. In contrast, when the inclination angle θ is excessively small, the length of the lid substrate 5 in the X axis direction is tend to be elongated, and thus it is not likely to sufficiently ensure a space for arranging the sealing material 7 in the support substrate 2.

Furthermore, in the lid substrate 5A, the through hole 52 is omitted.

In this embodiment, the sealing material 7 is disposed in a portion of the boundary portion K, which overlaps (intersects with) the edge portion of the concave portion 24A on the −X side in the lid substrate 5 when seen from the Z axis direction. In addition, the sealing material 7 flows into the +X axis side from the −X side of the end portion of the concave portion 24A in the lid substrate 5 when seen from the Z axis direction. The sealing material 7 adheres to the lower surface of the lid substrate 5, the inner surface of the concave portion 24A, and the upper surface of the insulating film 6 in the concave portion 24. Accordingly, it is possible to make airtightness of the concave portion 51 excellent.

Further, the sealing material 7 also adheres to the side surface 54 of the lid substrate 5. Accordingly, it is possible to increase a contact area between the sealing material 7 and the lid substrate 5, and according to this, it is possible to increase bonding strength between the sealing material 7, and the support substrate 2 and the lid substrate 5A. Accordingly, it is possible to effectively prevent or suppress separation of the sealing material 7 from the lid substrate 5 and the support substrate 2.

Next, a manufacturing method of the physical quantity sensor 1A will be described.

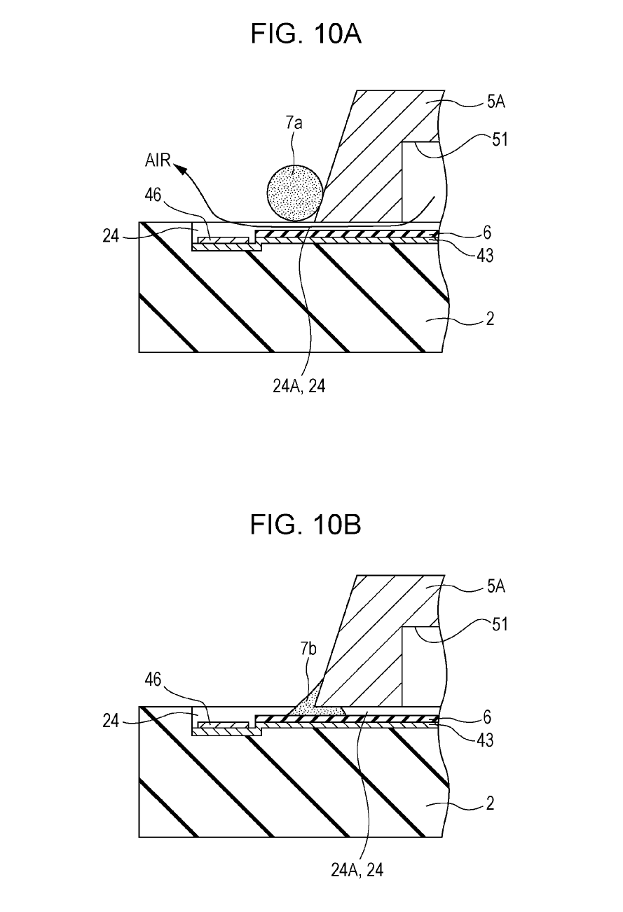

FIGS. 10A and 10B are sectional views illustrating a manufacturing method of the physical quantity sensor illustrated in FIG. 9, FIG. 10A is a diagram illustrating a pressure adjustment step, and FIG. 10B is a diagram illustrating a sealing step.

The manufacturing method of the physical quantity sensor in this embodiment includes (1′) Preparation Step, (2′) Arrangement Step, (3′) Bonding Step, (4′) Pressure Adjustment Step, and (5′) Sealing Step.

### (1′) Preparation Step

First, the support substrate 2 in which the element piece 3 is disposed on the upper surface, and the lid substrate 5A are prepared.

### (2′) Arrangement Step

Subsequently, as illustrated in FIG. 10A, the sealing material 7a is arranged on the upper surface of the support substrate to be in contact with the side surface 54 of the lid substrate 5A.

### (3′) Bonding Step

Subsequently, the support substrate 2 and the lid substrate 5A are put into a chamber (not illustrated) in this arrangement state, and the support substrate 2 is bonded to the lid substrate 5A by anode bonding.

### (4′) Pressure Adjustment Step

Subsequently, a step identical to (4) Pressure Step of the first embodiment is performed.

### (5′) Sealing Step

Then, as illustrated in FIG. 10B, the chamber 100 is heated, the temperature of the chamber 100 is set to the temperature Tb which is higher than or equal to the melting point T7 of the sealing material 7a and lower than the melting point T2 of the support substrate 2 and the melting point T5 of the lid substrate 5, and the sealing material 7a is melted in the through hole 52.

At this time, the melted sealing material 7b is in contact with the side surface 54, and seals the concave portion 24A.

In addition, the viscosity of the sealing material 7b depends on the depth of the concave portions 22 to 24, but is not particularly limited insofar as the sealing material 7b is able to flow into the concave portions 22 to 24 from the edge portion of the lid substrate 5 on the −X side. Specifically, the viscosity of the sealing material 7b is preferably greater than or equal to 0.5×10³ Pa·s and is less than or equal to 10×10³ Pa·s, and is more preferably greater than or equal to 2×10⁻³ Pa·s and less than or equal to 5×10³ Pa·s.

When the viscosity of the sealing material 7b is excessively low, the sealing material 7b excessively spreads on the insulating film 6, and according to the degree of spread, the sealing material 7b may reach the electrodes 44 to 46. In contrast, when the viscosity of the sealing material 7b is excessively high, the amount of sealing material 7b which flows into the concave portion 24 decreases.

Then, finally, the sealing material 7b is coagulated, and thus it is possible to obtain the physical quantity sensor 1A.

Thus, according to this embodiment, the through hole 52 in the first embodiment is able to be omitted. Accordingly, the lid substrate 5 is able to be simply configured.

### Third Embodiment

Next, a third embodiment of the physical quantity sensor of the invention will be described.

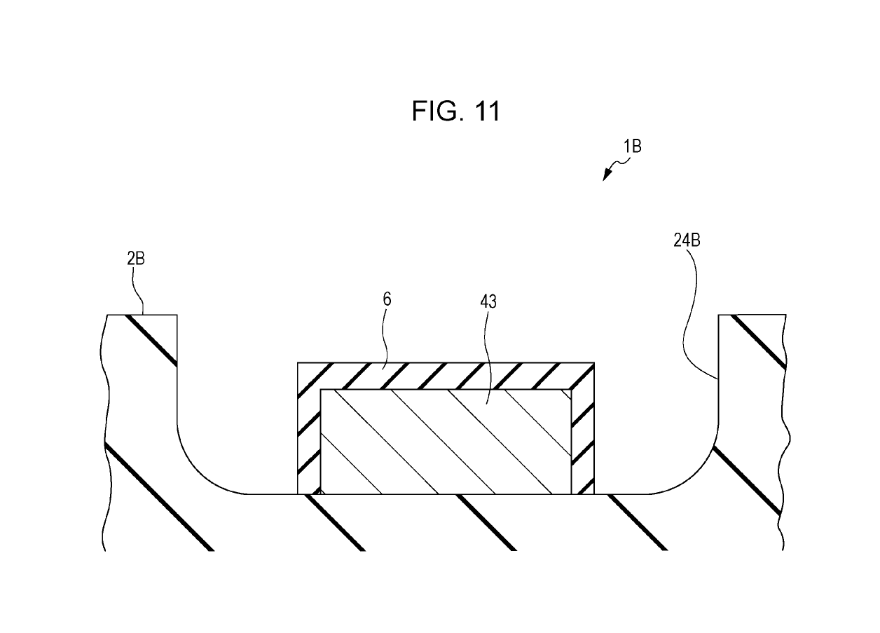

FIG. 11 is an enlarged sectional view illustrating a third embodiment of the physical quantity sensor of the invention.

Hereinafter, a third embodiment of the physical quantity sensor will be described with reference to the drawings focusing on differences with respect to the embodiments described above, and the description of the same configurations will be omitted.

The third embodiment is approximately identical to the first embodiment except that the shape of the concave portion is different.

As illustrated in FIG. 11, a support substrate 2B of a physical quantity sensor 1B includes a concave portion 24B in which the wiring 43 is arranged. The concave portion 24B is formed of a surface in which a boundary portion between the bottom surface and the side surface of the inner surface is rounded and continuous. Accordingly, when the liquid sealing material 7b flows into the concave portion 24B, the sealing material 7b easily flows into the corner of the concave portion 24B, and thus is able to adhere to the inner surface of the concave portion 24B. Accordingly, it is possible to make the airtightness of the concave portion more excellent. Accordingly, the physical quantity sensor 1B has higher reliability.

In addition, when the support substrate 2, for example, is configured of a glass material, the concave portion 24B having such a shape is able to be easily obtained by performing wet etching.

A mixed solution containing an aqueous solution of a hydrofluoric acid as a main component is able to be preferably used as an etching solution.

Furthermore, even though it is not illustrated, in the physical quantity sensor 1B, each of the concave portions in which the wirings 41 and 42 are arranged also has the same shape as that of the concave portion 24B.

### 2. Electronic Device

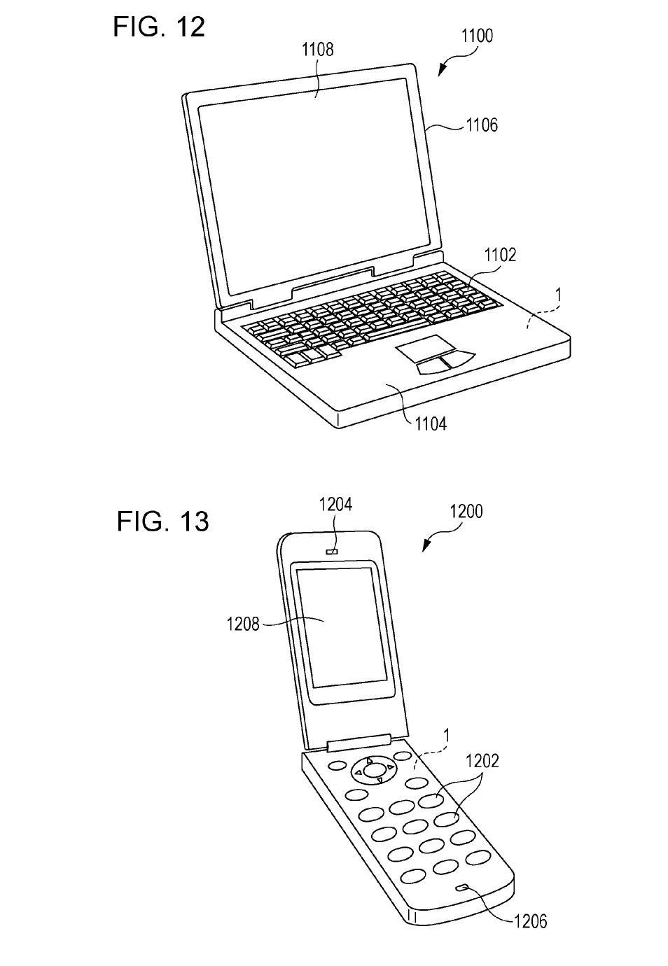

Subsequently, an electronic device to which physical quantity sensor 1 is applied will be described in detail on the basis of FIG. 12 to FIG. 14.

FIG. 12 is a perspective view illustrating a configuration of a mobile (a note-type) personal computer to which an electronic device including the physical quantity sensor of the invention is applied. In this drawing, a personal computer 1100 is configured of a main body portion 1104 including a keyboard 1102, and a display unit 1106 including a display section 1108, and the display unit 1106 is rotatably supported with respect to the main body portion 1104 through a hinge structure portion. In the personal computer 1100, the physical quantity sensor 1 which functions as an angular velocity detection unit is embedded.

FIG. 13 is a perspective view illustrating a configuration of a mobile phone (also including PHS) to which an electronic device including the physical quantity sensor of the invention is applied. In this drawing, a mobile phone 1200 includes a plurality of operation buttons 1202, an ear piece 1204, and a mouthpiece 1206, and a display section 1208 is arranged between the operation button 1202 and the ear piece 1204. In the mobile phone 1200, the physical quantity sensor 1 which functions as an angular velocity detection unit is embedded.

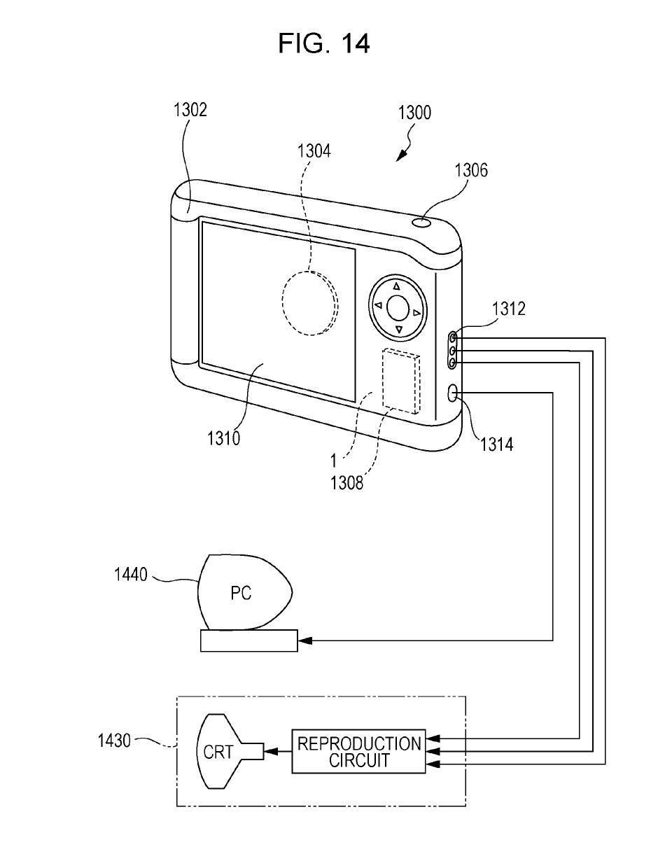

FIG. 14 is a perspective view illustrating a configuration of a digital still camera to which an electronic device including the physical quantity sensor of the invention is applied. Furthermore, in this drawing, connection with respect to an external device is also simply illustrated. Here, an ordinary camera is sensitive to a silver salt photographic film by a light image of an object, and the digital still camera 1300 generates an imaging signal (an image signal) by performing photoelectric conversion with respect to the light image of the object using an imaging element such as a Charge Coupled Device (CCD).

A display section is disposed on the back surface of a case (a body) 1302 of the digital still camera 1300 and performs display on the basis of the imaging signal of the CCD, and the display section 1310 functions as a finder which displays the object as an electronic image.

In addition, a light receiving unit 1304 including optical lens (an imaging optical system), the CCD, or the like is disposed on the front surface side of the case 1302 (in the drawing, the back surface side).

When a photographer confirms an object image displayed on the display section and presses a shutter button 1306, the imaging signal of the CCD at this time is transmitted to and stored in a memory 1308.

In addition, in the digital still camera 1300, a video signal output terminal 1312 and input and output terminal for data communication 1314 are disposed on the side surface of the case 1302. Then, as illustrated, a television monitor 1430 is connected to the video signal output terminal 1312 and a personal computer 1440 is connected to the input and output terminal for data communication 1314, as necessary. Further, the imaging signal stored in the memory 1308 is output to the television monitor 1430 or the personal computer 1440 according to a predetermined operation.

In the digital still camera 1300, the physical quantity sensor 1 which functions as an angular velocity detection unit is embedded.

Furthermore, the electronic device including the physical quantity sensor of the invention is able to be applied to, for example, an ink jet type discharge device (for example, an ink jet printer), a lap top type personal computer, a television, a video camera, a video tape recorder, a car navigation device, a pager, an electronic notebook (also including an electronic notebook having a communication function), an electronic dictionary, a calculator, an electronic game device, a word processor, a workstation, a video telephone, a television monitor for crime prevention, an electronic binocular telescope, a POS terminal, a medical treatment device (for example, an electronic thermometer, a hemadynamometer, a blood sugar meter, an electrocardiographic device, an ultrasonic diagnosis device, and an electronic endoscope), a fish finder, various measurement devices, meters (for example, meters for a vehicle, an aircraft, and a vessel), a flight simulator, and the like in addition to the personal computer (the mobile personal computer) of FIG. 12, the mobile phone of FIG. 13, and the digital still camera of FIG. 14.

### 3. Moving Object

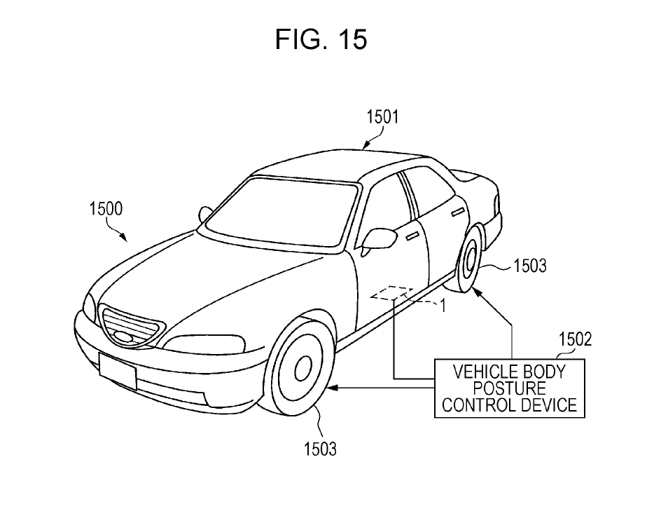

Subsequently, a moving object to which the physical quantity sensor of the invention is applied will be described in detail on the basis of FIG. 15.

FIG. 15 is a perspective view illustrating a configuration of an automobile to which a moving object including the physical quantity sensor of the invention is applied. In an automobile 1500, the physical quantity sensor 1 which functions as an angular velocity detection unit is embedded, and the posture of a vehicle body 1501 is able to be detected by the physical quantity sensor 1. A signal from the physical quantity sensor 1 is supplied to a vehicle body posture control device 1502, and the vehicle body posture control device 1502 detects the posture of the vehicle body 1501 on the basis of the signal, and thus is able to control hardness and softness of suspension according to the detection result or to control a brake of each wheel 1503. In addition, such posture control is able to be used in a bipedal robot or a radio-controlled helicopter. As described above, the physical quantity sensor 1 is incorporated in order to realize posture control of various movable bodies.

As described above, the illustrated embodiments of the physical quantity sensor of the invention are described, but the invention is not limited thereto, and each portion configuring the physical quantity sensor is able to be substituted with a portion having an arbitrary configuration which is able to exhibit the same function. In addition, an arbitrary component may be added.

In addition, the physical quantity sensor, the electronic device, and the moving object of the invention may be combined with two or more arbitrary configurations (characteristics) in each of the embodiments described above.

In addition, in each of the embodiments, the lid substrate is formed by processing a silicon single crystal substrate in which a main surface includes a (100) surface of silicon, but the invention is not limited thereto, and for example, the lid substrate may be formed by processing a base material of a single crystal substrate including a (110) surface of silicon.

The entire disclosure of Japanese Patent Application No. 2014-236284, filed Nov. 21, 2014 is expressly incorporated by reference herein.

What is claimed is:

1. A physical quantity sensor, comprising:
a sensor element;
a support substrate in which the sensor element is arranged on one surface and a groove is disposed on the one surface;
wiring which is disposed in the groove and is electrically connected to the sensor element;
a lid substrate which is bonded to the one surface and contains the sensor element; and
a sealing material which seals the groove in a boundary portion between the lid substrate in the groove and the support substrate and has a melting point lower than a melting point or a softening point of the support substrate and the lid substrate.

2. The physical quantity sensor according to claim 1,
wherein a through hole which passes through the lid substrate in a thickness direction and is communicated with the groove is formed in the lid substrate, and the groove in the boundary portion formed by the through hole is sealed with the sealing material.

3. The physical quantity sensor according to claim 2,
wherein the sealing material collectively seals the through hole and the groove.

4. The physical quantity sensor according to claim 2,
wherein a plurality of the grooves are disposed, and the through hole intersects with each of the plurality of grooves in a plan view of the lid substrate.

5. The physical quantity sensor according to claim 1,
wherein the sealing material is arranged in a position which is the boundary portion and an edge portion of the lid substrate.

6. The physical quantity sensor according to claim 1,
wherein the sealing material includes a metal material or a glass material having a low melting point.

7. The physical quantity sensor according to claim 1, further comprising:
an insulating layer which covers a surface of the wiring.

8. An electronic device, comprising:
the physical quantity sensor according to claim 1.

9. An electronic device, comprising:
the physical quantity sensor according to claim 2.

10. An electronic device, comprising:
the physical quantity sensor according to claim 3.

11. An electronic device, comprising:
the physical quantity sensor according to claim 4.

12. An electronic device, comprising:
the physical quantity sensor according to claim 5.

13. An electronic device, comprising:
the physical quantity sensor according to claim 6.

14. An electronic device, comprising:
the physical quantity sensor according to claim 7.

15. A moving object, comprising:
the physical quantity sensor according to claim 1.

16. A moving object, comprising:
the physical quantity sensor according to claim 2.

17. A moving object, comprising:
the physical quantity sensor according to claim 3.

18. A moving object, comprising:
the physical quantity sensor according to claim 4.

19. A moving object, comprising:
the physical quantity sensor according to claim 5.

20. A moving object, comprising:
the physical quantity sensor according to claim 6.
